(19) United States
(12) Patent Application Publication
(10) Pub. No.: US 2019/0114589 A1
(43) Pub. Date: Apr. 18, 2019

(54) HOUSING ASSISTANCE APPLICATION AUDIT MANAGEMENT SYSTEM AND METHOD

(71) Applicant: RightSource Compliance, Minneapolis, MN (US)

(72) Inventors: CHRISTOPHER VOSS, Minneapolis, MN (US); DAVID CHAMBERLAIN, Woodbury, MN (US); QUINN FLANAGAN, Minneapolis, MN (US); NATE CHRYSLER, Minneapolis, MN (US); SYDNEY ANDERSON, Minneapolis, MN (US); NATALIA TRENT, Lakeville, MN (US)

(21) Appl. No.: 16/162,056

(22) Filed: Oct. 16, 2018

Related U.S. Application Data
(60) Provisional application No. 62/573,066, filed on Oct. 16, 2017.

(51) Int. Cl. G06Q 10/10; G06Q 50/16; G06F 3/0482

(52) U.S. Cl. CPC G06Q 10/10; G06F 3/0482; G06Q 50/163

(57) ABSTRACT

Described are computer-based systems and methods, including computer program products, for managing a housing assistance application process. In some examples, a method includes receiving user input including a set of criteria for a prospective tenant and a housing organization. The method also includes generating a packet of forms comprising at least one application for a selected publicly available housing assistance program from among a plurality of publicly available housing assistance programs having heterogeneous eligibility requirements and application forms. The method further includes facilitating an auditing process on the completed packet to determine an eligibility of the prospective tenant for the publicly available housing assistance program, and transmitting at least one customized status notification message regarding an audit status of the completed packet.

### CROSS-REFERENCE TO RELATED APPLICATIONS

The present application claims priority from U.S. Provisional Patent Application No. 62/573,066, filed on Oct. 16, 2017, the disclosure of which is incorporated by reference in its entirety.

### TECHNICAL FIELD

The present invention relates generally to computer-based systems and methods, including computer programs for management of auditing processes for housing assistance applications.

### BACKGROUND

There are many programs for providing rental assistance for low-income families or individuals. Examples of rental assistance programs may include, but are not limited to, Section 8 Housing, Section 236 Preservation Program, Project Rental Assistance Contract (PRAC), Family Homeless Prevention & Assistance Program (FHPAP), Public & Indian Housing, other Federal or State assistance programs, and emergency assistance through local municipalities.

Generally, the process for applying for rental assistance requires a prospective tenant to complete a set of forms and have them reviewed to verify compliance with and ensure correct application of requirements. The forms required are dependent on the type of property desired, the family size, income level, and the number of dependents in the household, among other things. Each of these factors may require a different set of forms to be properly filled out for approval. Often, the correct forms are not filled out, or the forms are not filled out correctly or completely.

Traditionally, housing assistance application forms are manually analyzed by an individual. Often, the individual make mistakes during the review process, which increases the time it take for an application to be reviewed. This also increases costs because it takes the individual longer to process the application.

Similar issues exist in the general rental housing application process; although forms may be customized for specific rental companies rather than for an organization or governmental entity, rental companies may provide a single form applicable for many properties under their management; those forms may often be filled out in an incomplete or erroneous manner by leasing agents at the various properties under management. Review and assessment of application accuracy may not be required in this context, but may be advisable.

For these and other reasons, improvements in the area of auditing are desired.

### SUMMARY

In accordance with the following disclosure, the above and other issues are addressed by the following:

In a first aspect, a method of managing a housing assistance application process comprises receiving a software tool implemented on a computing system where user input includes a set of criteria for a prospective tenant and a housing organization. Based on the prospective tenant and the housing organization, the software tool generates a packet of forms comprising at least one application for a selected publicly available housing assistance program from among a plurality of publicly available housing assistance programs, having heterogeneous eligibility requirements and application forms. The packet includes a plurality of pages, and each page has a unique identifier thereon identifying the page uniquely relative to any other page of the packet or other application forms. The software tool receives a completed packed that represents an application for the selected publicly available housing assistance program and performs an auditing process on the completed packet to determine an eligibility of the prospective tenant for the publicly available housing assistance program. Finally, at least one customized status notification message regarding an audit status of the completed packet is transmitted to a submitter, the submitter being at least one of the perspective tenant and the housing organization.

In another example embodiment, a system for managing a housing assistance application process include a database and a software tool. The database stores tenant information, housing organization information, and a plurality of application forms associated with a plurality of publicly available housing assistance programs having heterogeneous eligibility requirements. The software tool is executed on a computing system and is configured to receive user input including a set of criteria for a prospective tenant and a housing organization. Based on the prospective tenant and the housing organization, a packet of forms comprising at least one application for a selected publicly available housing assistance program from among the application forms in the database is generated. The packet include a plurality of pages, and each page has a unique identifier printed thereon identifying the page uniquely relative to any other page of the packet or other application forms. Then the completed packet representing an application for the selected publicly available housing assistance program is received. An auditing process is initiated on the completed packet to determine an eligibility of the prospective tenant for the publicly available housing assistance program. Then, at least one customized status notification message regarding an audit status of the completed packet is transmitted to a submitter of the completed packet. The submitted is at least one of the prospective tenant and the housing organization, and the audit status identifies one or more corrective tasks to be completed to obtain approval of the application of the selected publicly available housing assistance program.

In a further example, a non-transitory computer-readable medium comprising computer-executable instructions is disclosed. When executed by a computing system, the instructions cause the computing system to perform a method of managing a housing assistance application process. The method includes: receiving user input including a set of criteria for a prospective tenant and a housing organization; in response to the identification of the housing organization and the prospective tenant, identifying to the submitter one or more eligible publicly available housing assistance programs from among the plurality of publicly available housing assistance programs, wherein the selected publicly available housing assistance program is selected from among the identified one or more eligible publicly available housing assistance programs; based on the prospective tenant and the housing organization, generating a packet of forms comprising at least one application for a selected publicly available housing assistance program from among a plurality of publicly available housing assistance programs having heterogeneous eligibility requirements and application forms, wherein the packet includes a plurality of pages, each page having a unique identifier thereon identifying the page uniquely relative to any other page of the packet or other application forms; receiving at the software tool a completed packet representing an application for the selected publicly available housing assistance program; generating an auditing user interface accessible by an audit user; facilitating an auditing process on the completed packet to determine an eligibility of the prospective tenant for the publicly available housing assistance program; and automatically transmitting, in response to one or more stages of the auditing process, at least one customized status notification message to a submitter of the completed packet, the at least one customized status notification message regarding an audit status of the completed packet, the submitter being at least one of the prospective tenant and the housing organization.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an overall network in which property managers, third parties, and housing organizations can interact, according to an example embodiment;

FIG. 2 is a schematic illustration of an example of an automated auditing process according to an example embodiment;

FIG. 3 is a schematic illustration of an example computing system in which aspects of the present disclosure can be implemented;

FIG. 4 illustrates a block diagram of a server usable in connection with the present disclosure;

FIG. 5 shows a flow chart of a method of generating a packing of forms, according to an example embodiment;

FIG. 6 is a screenshot of a set of eligibility programs with which a set of applicable forms can be generated;

FIG. 7 is a screenshot of a set of packets useable for distribution to a user, according to an example embodiment;

FIG. 8 is an example page from one form useable in connection with the present disclosure;

FIG. 9 shows a flow chart of a method of processing a packet that is returned for auditing, according to an example embodiment;

FIG. 10 is a screenshot of a screen to create a new tenant within the platform described herein, in an example embodiment;

FIG. 11 is a screenshot of an auditing screen within the platform described herein, in an example embodiment;

FIG. 12 is a screenshot of a finding resolution screen useable within the platform described herein, in an example embodiment;

FIG. 13 is a screenshot of a checklist used in connection with an auditing process performed on a returned packet, according to an example embodiment;

FIG. 14 is a screenshot of a user contact form used in connection with an auditing process performed on a returned packet, according to an example embodiment;

FIG. 15 illustrates a flow chart of an auditing process according to an embodiment of the present disclosure;

FIG. 16 shows a screenshot of a list of example communication templates;

FIG. 17 illustrates an automated communication to a client regarding a status of one or more audit processes; and

FIG. 18 illustrates a status report provided in response to client access of a website in response to an automated communication.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to methods and systems for managing an auditing process for housing assistance applications. The housing assistance programs, as discussed herein, can include any of a variety of types of programs, including federal and local assistance programs. Often, applications for housing assistance are completed incorrectly, either due to use of wrong or out of date forms, or due to failure to accurately or completely fill out the application in a manner acceptable to the organization providing assistance. Accordingly, it is often desirable (and in many cases required) to have such applications audited to assess their completeness and accuracy. The auditing process is time consuming and also has a level of inaccuracy, due to its human nature. Additionally, because audits are for housing assistance, time is often of the essence to complete such audits and qualify potential tenants for assistance. Potential tenants, and the housing organizations that offer housing that complies with housing assistance program requirements, are often left uninformed as to the status of a housing assistance application, and may not know for some time that an incorrect or out of date form was used in the application, or that a correctly-selected application form was nevertheless completed inaccurately. Furthermore, auditors lack adequate tools to assist in streamlining their workflows. Because auditors may have varying experience levels, audits are therefore performed relatively inconsistently, and are a highly variable process.

In accordance with the following disclosure, methods and systems for management of such an application preparation and auditing process are provided. The methods and systems described herein may be provided by auditors to housing organizations to ensure that correct housing assistance applications are provided to housing organizations and potential tenants, to avoid wasting their time filling out applications for programs that the organization or tenant is not eligible for. The methods and systems described herein also provide end-to-end tracking of completed applications, including unique coding of application pages to allow for corrected portions of a housing assistance application to readily be linked to previously-completed, flawed versions of the same application, and to allow auditors to more readily know what types of information should be expected on any particular page of the application. The methods and systems therefore offer new and existing property managers a fast, easy and secure way to obtain audits of applications for rental assistance programs, making the tenant qualification process substantially easier. Additionally, in some embodiments, the system may include an administrative portal or user interface through which the providing financial auditor may view the status of and reports relating to all prospective tenants and properties, and provide training to housing organizations to improve application quality.

I. Application Generation, Audit Process, and Environment

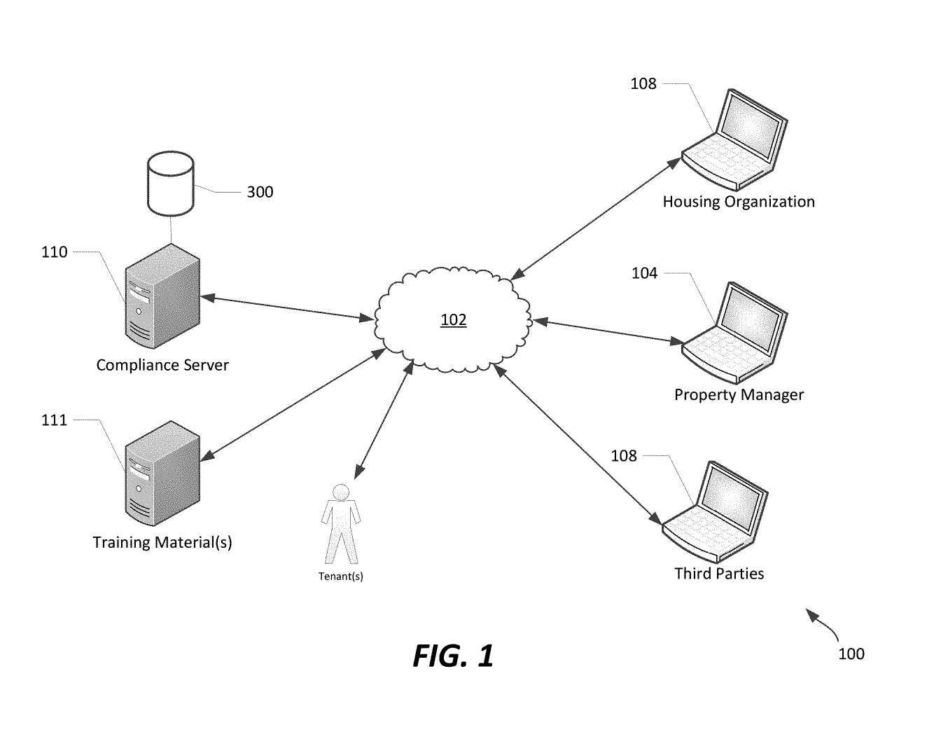

Referring now to FIG. 1, a generalized computing environment in which aspects of the present disclosure can be implemented is disclosed. FIG. 1 illustrates an overall system 100, in which users of a software tool can interact with property managers 104, housing organization 106, and third parties 108, over a network 102, according to an example embodiment of the present disclosure.

In the exemplary embodiment shown, the system 100 includes a server 110, a property manager 104, a housing organization 106, and a third party 108. Although not shown, network 102 may include more than property manager 104, more than housing organization 106, and more than one third party 108.

A third party 108 may be a federal or state entity that provides rental assistance programs. Examples of vendors may be the U.S. Department of Housing and Urban Development (HUD), Minnesota Housing, and numerous local governmental agencies. Each program has different documents related to the rental assistance program or subsidized housing program that must be completed to apply for the program. For example, a local public housing agency provides the paperwork for verifying a Section 8 voucher. This paperwork can be obtained at the time of applying for housing from the third party 108 to ensure the correct and up-to-date form is used.

Property managers 104 include properties owned both publicly and privately. The property managers 104 may also have their own documents relating to rental properties that need to be completed by a prospective tenant. Examples of documents may include a lease application, proof of funds or proof of assistance, and other similar documents. These documents may also be obtained at the time of applying for housing from the property manager 104.

In the embodiment shown, a server 110 is also communicatively connected to the network 102. The server 110 generally manages the auditing process, as described in further detail below. Although shown as a single server, the server 110 can be implemented using one or more networked and/or distributed computing systems, such as may be present in a cloud-computing environment.

In some embodiments, a training server 111 can also be included within the environment 100. The training server 111 may host one or more sets of training materials available to housing management companies, for example to provide to sales agents or other employees who may be tasked with assisting potential housing applications in qualifying for housing assistance, or completing an application to qualify for housing at all.

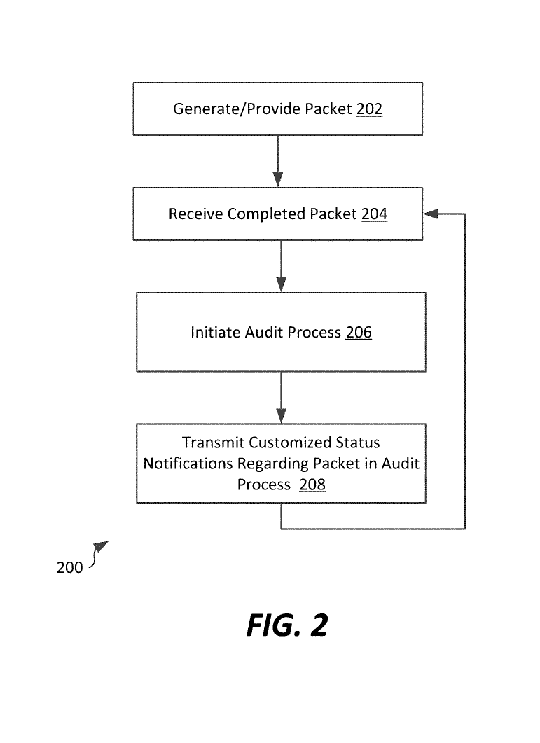

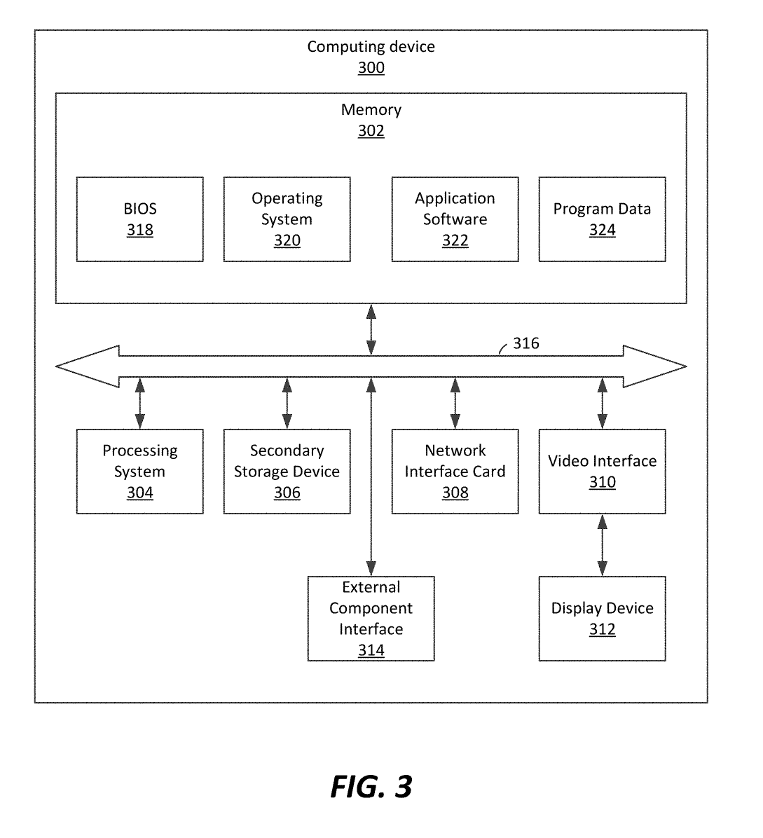

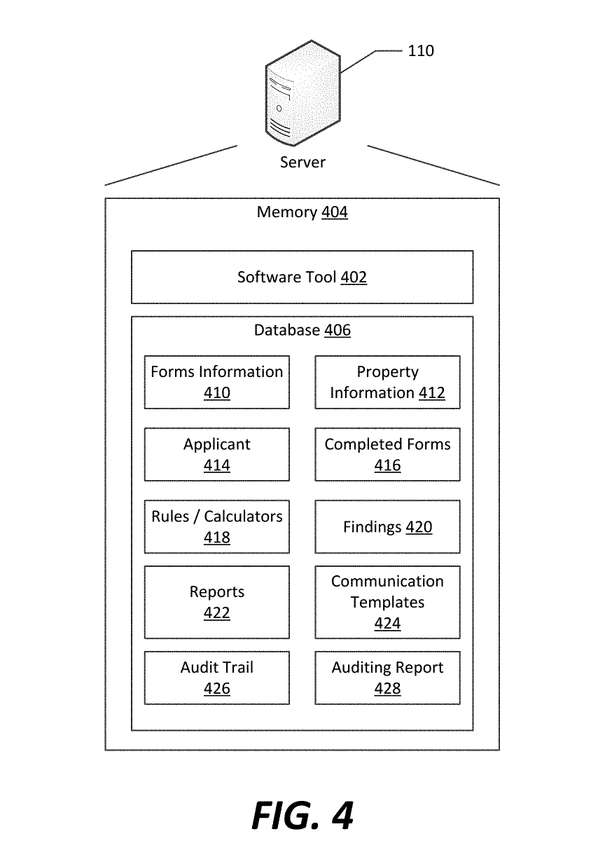

An overall process 200 for managing an application and auditing process for a packet of forms for applying for a housing assistance program is generally shown in FIG. 2. The process 200 can be performed, for example, by a software tool such as the software tool described below in connection with FIGS. 3-4, or using the user interfaces described herein.

In the embodiment shown, the process 200 generally includes generating and/or providing a packet of forms (step 202), having the prospective tenant receive and complete the packet and return it to the housing organization (step 204), performing an auditing process on the packet (step 206), and sending a customized status notification (step 208). The process 200 may include additional steps, for example correcting discrepancies in a packet in response to the auditing process, or otherwise facilitating interaction between an auditor and a property manager to address any questions that may arise during the auditing process (as further described below). In an example embodiment, the process 200 is web-based and is executable by a software tool hosted by a server, e.g., over the Internet with a computer.

Currently, rental assistance programs require forms to be filled out in hard copy by the prospective tenant. The software tool generates the packet of forms (step 202) and can be printed so the prospective tenant can complete the forms in hard copy, or distributed to the prospective tenant in electronic form (e.g., in a portable document format, or via a web-Tillable form). Generating the packet of forms in the manner described below ensures that correct and up-to-date forms are selected and provided to the prospective tenant, and provides tracking and management features for ensuring complete return of those forms for auditing.

In example embodiments, the user can be an employee of a housing organization, and once a forms packet is received from the software tool the user can print those forms and provide them to a prospective tenant for completion. In some embodiments, forms are also sent to third parties for completion, such as a bank or employer from whom income verification details are sought for the prospective tenant. Once the forms are completed, they are returned to the housing organization/user. In yet another embodiment, the forms may be filled out electronically by the prospective tenant and/or the third party. The prospective tenant and/or the third party can then send the completed forms back to the user or upload them directly to the auditing program.

After the forms are completed in hard copy (or electrically) and returned to the user, the forms are uploaded to the software tool, which receives the forms and stores them in a database of completed forms for further processing (step 204). The software tool can then indicate to an audit user that the application forms are available for review, as well as a time at which the forms were received, to ensure prompt processing. In some embodiments, the software tool can provide to the audit user a user interface to assist the audit user with an auditing process (step 206). The auditing process generally includes a verification that (1) the form is compliant (e.g., is the correct form, and the user is eligible for that housing assistance program), (2) the form is completed correctly (e.g., there are no critical missing pieces of information, the form was completed in pen, no white-out was used, etc.), and (3) the form information is verifiable relative to third party sources (e.g., based on an income or credit check, or other background check that may be requested by the software tool).

Throughout the auditing process, and as discussed in further detail below, various customized notifications (step 208) can be generated and sent to the submitting user so that user can keep track of the application packet's status. For example, a customized message may indicate to the user that “prospective tenant X's application packet was successfully received” or that the application packet has entered a further processing stage. In example embodiments discussed below, the customized message may also include a link to a report that will allow the user to view any issues that may have been identified during the audit process. Such issues may include messages such as “prospective tenant X's application packet appears incomplete because pages 1 and 4 of housing assistance application Y appear missing” or “prospective tenant X's application packet requires correction of pages 2 and 3 due to [reasons—lack of signature, lack of employment or income information, etc.]”. Ultimately, a completed audit notification can be sent indicating an approval or disapproval of the housing application(s) included in the application packet, or could be included within an updated version of such a report.

Referring now to FIG. 3, an example computing device 300 useable to implement aspects of the present disclosure is described. The computing device 300 can be used, for example, to implement servers 110, 111 of FIG. 1, or user/client devices also illustrated.

In the example of FIG. 3, the computing device 300 includes a memory 302, a processing system 304, a secondary storage device 306, a network interface card 308, a video interface 310, a display unit 312, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media, and generally includes at least some tangible media. In some embodiments, the memory 302 is implemented using entirely non-transitory media.

The processing system 304 includes one or more processing units, or programmable circuits. A processing unit is a physical device or article of manufacture comprising one or more integrated circuits that selectively execute software instructions. In various embodiments, the processing system 304 is implemented in various ways. For example, the processing system 304 can be implemented as one or more physical or logical processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid-state memory devices, and/or other types of tangible computer storage media.

The network interface card 308 enables the computing device 300 to send data to and receive data from a communication network. In different embodiments, the network interface card 308 is implemented in different ways. For example, the network interface card 308 can be implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display unit 312. The display unit 312 can be various types of devices for displaying video information, such as an LCD display panel, a plasma screen display panel, a touch-sensitive display panel, an LED screen, a cathode-ray tube display, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, and/or another type of interface that enables the computing device 300 to communicate with external devices. In various embodiments, the external component interface 314 enables the computing device 300 to communicate with various external components, such as external storage devices, input devices, speakers, modems, media player docks, other computing devices, scanners, digital cameras, and fingerprint readers.

The communication medium 316 facilitates communication among the hardware components of the computing device 300. The communications medium 316 facilitates communication among the memory 302, the processing system 304, the secondary storage device 306, the network interface card 308, the video interface 310, and the external component interface 314. The communications medium 316 can be implemented in various ways. For example, the communications medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 302 stores various types of data and/or software instructions. The memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. The memory 302 also stores program data 324. The program data 324 is data used by programs that execute on the computing device 300.

Although particular features are discussed herein as included within an electronic computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Referring now to FIG. 4, a particular computing system that can be used to implement server 110 is disclosed. The server 110 can, in some embodiments, include a memory 404 storing a software tool 402 and a database 406. The software tool 402 generally is configured to automatically generate and provide a forms packet to a user based on an indication of the eligibility of a prospective tenant and property organization to apply for specific housing assistance programs, and presents to an auditor a separate user interface useable to assess the received, completed application. Additional dashboards and other features are also provided to display the status of audit processes, alerts regarding issues in the audit process or application, are included as well. In addition, certain automated notification features are also included allowing submitting users to keep track of the auditor's progress in reviewing the application, and to immediately receive a notification in the event the auditor finds an issue that requires corrective action by the applicant. Other features are included in the software tool as well, as reflected below.

The database 406 stores data accessible to the software tool 402, which is used to manage the application and auditing processes. In an example embodiment, the database 406 stores form information 410, property information 412, applicant information 414, completed form information 416, rules 418, a predetermined set of findings 420, reports 422, communication templates 424, an audit trail 426, and audit report information 428. Other types of information can be stored in the database 406 as well.

The form information 410 includes, in some embodiments, a plurality of forms from a plurality of different housing assistance programs, as well as information regarding eligibility requirements associated with each of the forms. In example embodiments, and as discussed below, the forms are often multi-page application forms, and not all housing organizations are eligible for all housing assistance programs for which there are forms. Furthermore, each form can, in some embodiments, be modified at the server 200 when stored in the database 406 to include a unique identifier thereon. The unique identifier can be used to individually track each page of each form, to allow the server to determine, in a completed form, whether all pages of the form have been received, whether they have been received in order, and how to present those pages to an auditor. Furthermore, and as discussed in further detail below, the unique identifier associated with each of the form pages allows a user to replace (at least in a user view) only a single page if some corrective action is required with respect to one or more pages of the form, without having to resubmit an entirely different application; the software tool 402 resident at the server 200 can present, to the auditor, a set of form pages in sequence that includes the most up-to-date version of each page provided, whether part of an original or corrected completed form. Examples of forms and methods for retrieving such forms is described in further detail below.

The property information 412 includes information used to maintain and track a plurality of properties. This can include, for example, a list of properties that are managed using the application and auditing processes herein, as well as characteristics of each property, such as the number and types of units offered, current tenant lists, renewal dates for leases, eligibility requirements for particular units or buildings, address/location information and other types of information as well. Specific examples of property lists and methods of tracking properties is described in further detail below.

In the embodiment shown, the applicant information 414 is used to maintain and track a plurality of prospective tenants and approved tenants. Examples of prospective tenants and approved tenants lists and methods are described in further detail below and generally include tenant information, household size information, income information or other housing assistance program eligibility information and contact information for the tenant or prospective tenant.

The completed forms 416 include copies of completed forms submitted by a submitting user, which may be a prospective tenant or an employee of a housing organization on behalf of the prospective tenant. The completed forms 416 can include forms that have been submitted, are incorrect or incomplete, denied, and approved. This is explained in further detail below.

The rules and calculators 418 include sets of rules through which are used by the software tool during a forms creation process and an auditing process. For example, the rules 418 can include a set of rules regarding eligibility and linking specific forms to certain eligibility requirements, such that a prospective tenant can be provided with appropriate forms based on the specific housing accommodation sought and the characteristics of that prospective tenant. The rules 418 can also be used during the auditing process, for example to provide guidance to an auditor during an audit, to present appropriate forms to the auditor for review, to trigger automated customized notifications to users in response to various stages of the auditing process, or other actions. Additionally, the rules 418 can include one or more calculators useable to determine eligibility (e.g., based on verified income and other personal details received from the user in the housing application). Details regarding various types of rules are provided below.

The findings 420 can be selected for entry by an auditor, and represent the types of errirs that may be found on a housing assistance application. This can include, for example, critical and non-critical errors, where critical errors are required to be corrected by the prospective applicant before the auditing process can occur. Non-critical errors are also required to be corrected before an application is approved or denied, but the auditing process can continue even with the presence of non-critical errors.

In the embodiment shown, the reports 422 include a plurality of reports that are generated by the software tool 402. A variety of reports can be generated regarding performance metrics associated with the application generation, completion, and auditing processes described herein.

The communication templates information 424 includes a plurality of communication templates. This can include, for example, email templates that can be sent to a prospective tenant or property manager to notify them that an action has occurred regarding the completed forms. Communication templates can notify the prospective tenant or property manager that the application has been received, the application is being audited, there are incomplete or incorrect sections that need to be fixed, and that an application has been denied or approved. The software tool 402 is capable of generating and sending communications as needed utilizing the communication template information 424. Examples of communication templates and methods of creating and sending communications are further described in detail below.

The database 406 also includes an audit trail information 426 and audit reporting information 428. The audit trail information 426 stores information regarding the auditing process, such as when an application was received, when an audit was started on the application and how long it took to complete the audit. Other information includes how long it took for an error or incomplete packet to be fixed and re-submitted. The audit trail information 426 may also store information relating to which users accessed the application and which user audited the application.

The audit report information 428 stores information relating to the auditing process itself and information acquired through the audit. For example, the audit report information 428 contains information such as which pages of the completed packet had errors or were incomplete and whether. Audit reports may be created utilizing the audit report information 428 and includes information relating to errors that were found, incorrect calculations, and incomplete pages. Such information may be reviewed should a question arise, for example, if the prospective tenant or property manager questions a declined or approved application.

In use, when a property manager or prospective tenant requests housing utilizing a housing assistance program, the property manager or prospective tenant may utilize the software tool 402 to generate an appropriate packet to be distributed to the prospective tenant for completion.

Packets are created based on input criteria, such as where the rental property is located, where the tenant resides, which federal or state program the tenant is applying under, how many household members there are, if students are in the household, how many children are in the household, and other similar information. The software tool 402 allows a user to input this information and the software tool 402 generates the packet.

Each packet created is customized to the prospective tenant and the property they are applying to lease. Any number of combinations of forms are envisioned. The software tool 402 is capable of automatically generating the applicable forms based on the input criteria, so the user is not responsible for knowing what forms are required, whether those forms are up-to-date, what pages are required to be included with a particular form, or what supporting documentation may be required (e.g., third party verifications of application information).

II. Application Packet Generation

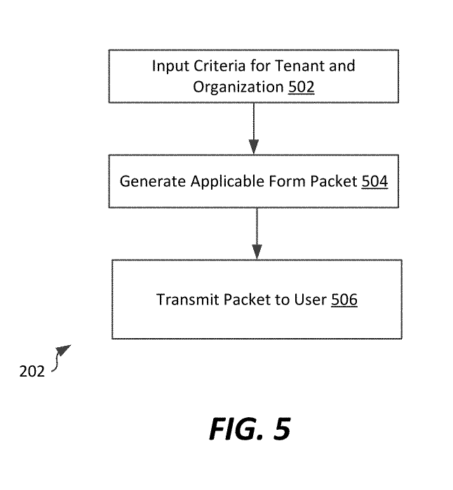

Referring now to FIGS. 5-8, an application generation process is described in further detail. As seen in FIG. 5, when a new prospective tenant is identified, a user is guided through a process for creating a packet with the correct forms 202. First, a user selects the packet category, signifying that the user needs to create a new packet. The user is guided through a packet creation process, which includes selecting a packet type selected from: application, lease, and re-certification. Additional selections are available depending on the type of housing assistance program is being applied to. Housing assistance programs may be selected from 202 PAC/202 PRAC, LIHPRHA Title VI, PRAC 811, Tax credit, Rural Development section 236, and Section 8. Other types of housing assistance programs are also available depending on the prospective tenant and the location of the property. The user is also directed to selecting a property, which determines if further forms are needed because some agencies, such as the Alabama Housing Finance Authority, California Tax Credit Allocation Committee, and Illinois Housing Development Authority require addition application materials. Once a user selects the packet type and housing assistance program, and inputs the prospective tenant information (step 502), the software tool acquires the appropriate forms and creates a packet unique to the inputs (step 504).

The software tool acquires forms at the time the prospective tenant is applying for housing. This ensures the correct forms and up-to-date forms are used. The forms may be stored on a local server and may be updated as needed. Alternatively, the forms may be acquired from a third party's server, such as HUD, at the time of application. In example embodiments, the forms are managed at the server 110, for example being retrieved from a plurality of different public and/or private housing assistance programs. The forms therefore have different sources and are heterogeneous; generally, each of the housing assistance programs requires applicants to use the form created by and for that program. As such, for an applicant to properly complete forms, the applicant must properly identify the programs that the applicant and the housing organization are eligible for, as well as ensure that the forms obtained for completion are up to date. Furthermore, in typical scenarios, once those forms are completed, there is no feedback mechanism for notifying either the applicant or the housing organization of the status of a completed or rejected application, or a timeline for completion of review/audit of the application.

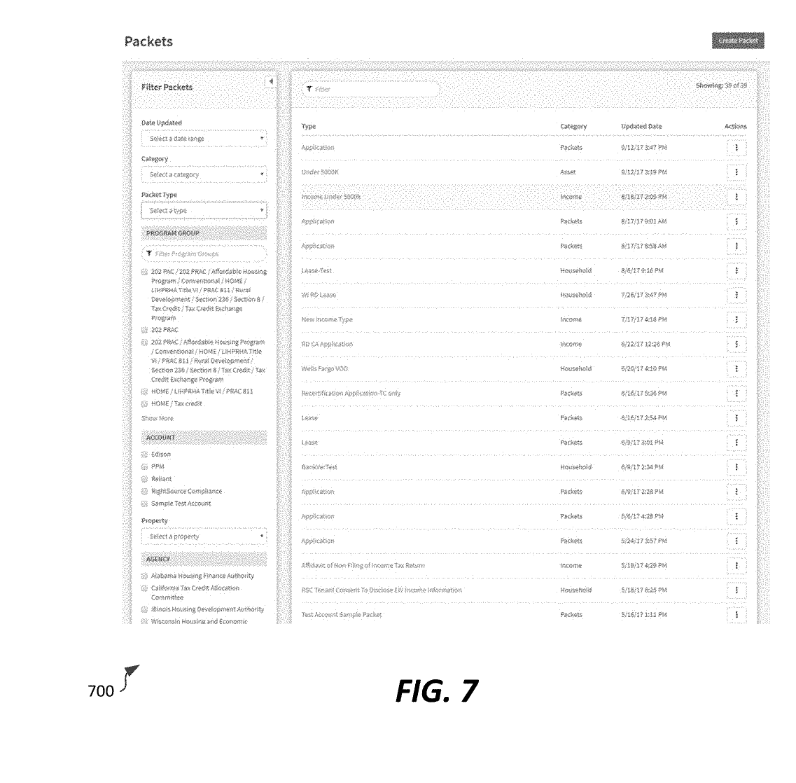

In example embodiments, the packets are created as an aggregate of one or more documents and forms. The documents may be stored in the database as forms information 410, and may be browsed and used for aggregation into a packet. Example documents and forms may be accessed and reviewed within a user interface, such as user interface 700 of FIG. 7. In the user interface 700, a user may search for or filer among forms available to be included in a packet based on, for example, date of upload, category, packet type, or specific program (e.g., housing assistance program) that is associated with the form. Additionally, specific forms for various housing agencies or accounts may be included as well, and filters may be available for each, as well as property-specific forms. Example forms may include, for example, a 236 fact sheet, 59, Section 8 application, application, CA rsc initial recertification TC with expenses, CA under $5000 asset certification, CA-tax credit lease addendum, Edison form, Housing Academy, HUD 1141, HUD citizen declaration, HUD consent to release, HUD eiv and you brochure, HUD race and ethnicity form, HUD resident rights and responsibilities, HUD section 8 fact sheet, HUD vawa, HUD 92006, HUD 9887, HUD 9887A, IL MI file checklist, Paramark 811, Paramark RD lease, PPM addendum to lease annual recertification notice, PPM CA RD lease, PPM CA RD rules and regulations, PPM CA ED Self-employment requirements, PPM California proposition 65 warning, PPM debit card phone verification, PPM Housing allowances for utilities and other public services, PPM HUD initial notice, PPM Information Release, PPM Lease guarantor application, PPM lease guaranty, PPM nonstandard rental provisions, PPM owners notice, PPM pet rule agreement, PPM prorated rent form, PPM rental housing construction program lease addendum Nevada woods, PPM tax credit agreement for low-income housing CA, PPM underutilization of unit, PPM Wisconsin RD lease, PPM HUD criminal check authorization, PPM owners summary, PPM PRAC MI checklist, PPM security deposit agreement, PPM security deposit payment agreement, PPM RHS 515 with section 8 agreement, PPM maple ridge lease, PRAC annual student certification, PRAC fact sheet, RD NOE, RD things to know in Spanish, RD change notice, Request for reasonable accommodation, RSC affidavit of non-filing or income tax return, RSC CA move-in S8, RSC tax credit TX move-in checklist, RSC tax credit TX recertification checklist, RSC tenant consent to disclose EIV income information, RSC asset verification, RSC assistive companion animal request, RSC bank verification, RSC family summary sheet, RSC initial application CA TC, RSC initial application S8, RSC initial application S8 TC, RSC initial application TC, RSC initial application RD, RSC initial application with HUD funding CA, RSC initial application with rural development, RSC landlord verification, RSC lump sum payment affidavit, RSC recertification application TC, RSC recertification application RD, RSC recertification application TC CA, RSC seasonal employment certification, RSC student certification S8, RSC acknowledgement of receipts, Sparks way rental lease, tenant income certification questionnaire, TX income verification for households with Section 8, Wells Fargo VOD, WI HUD PRAC rules and regulations, WI HUD TC rules and regulations, WI Tax credit student certification, and WI form 600 under 5000. While not listed, other forms may be used as well.

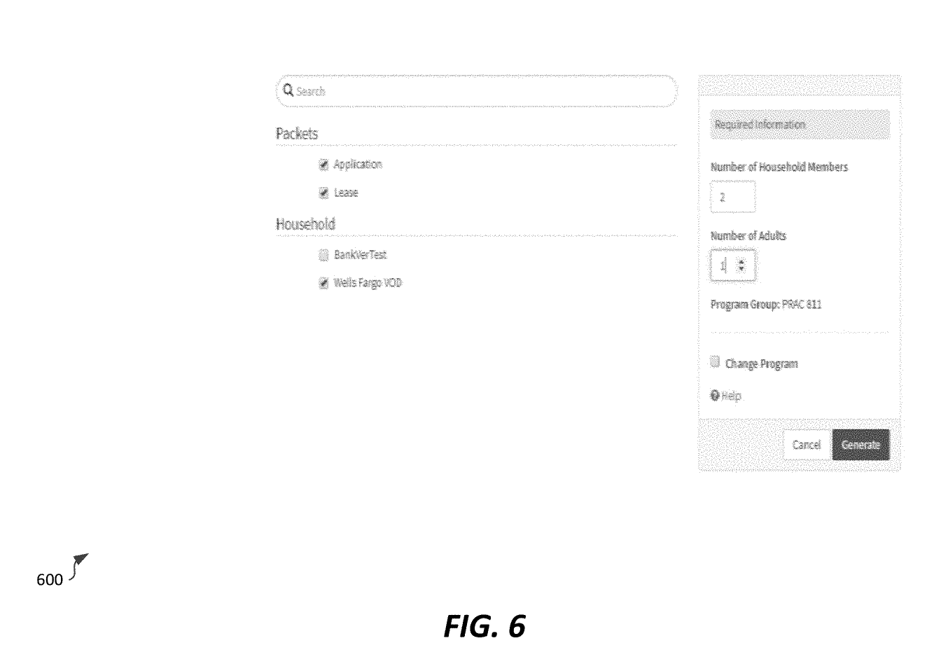

Based on the identified user and property, one or more forms are selected for inclusion in the packet to be distributed. FIG. 6 shows a screenshot of a Download Forms page 600. After a user has inputted criteria to create a packet of forms (e.g., the type of application, type of household, number of household members/adults, etc., the software tool prompts a user to download all the forms, since a packet can then be formed. After a packet is created, it is provided to the prospective tenant and/or the property manager (step 506). Initially, a user can download all the forms of the packet. If a replacement form or page is needed, a user is also able to download the individual form or page. The packet can be sent to the prospective tenant or property manager electronically or in hard copy.

In some instances, forms need to be completed by someone other than the prospective tenant or property manager. For example, some forms require bank certification, while others may require certification from an employer or other person. These forms either can be given to the prospective tenant for distribution, or may be given directly to the third party.

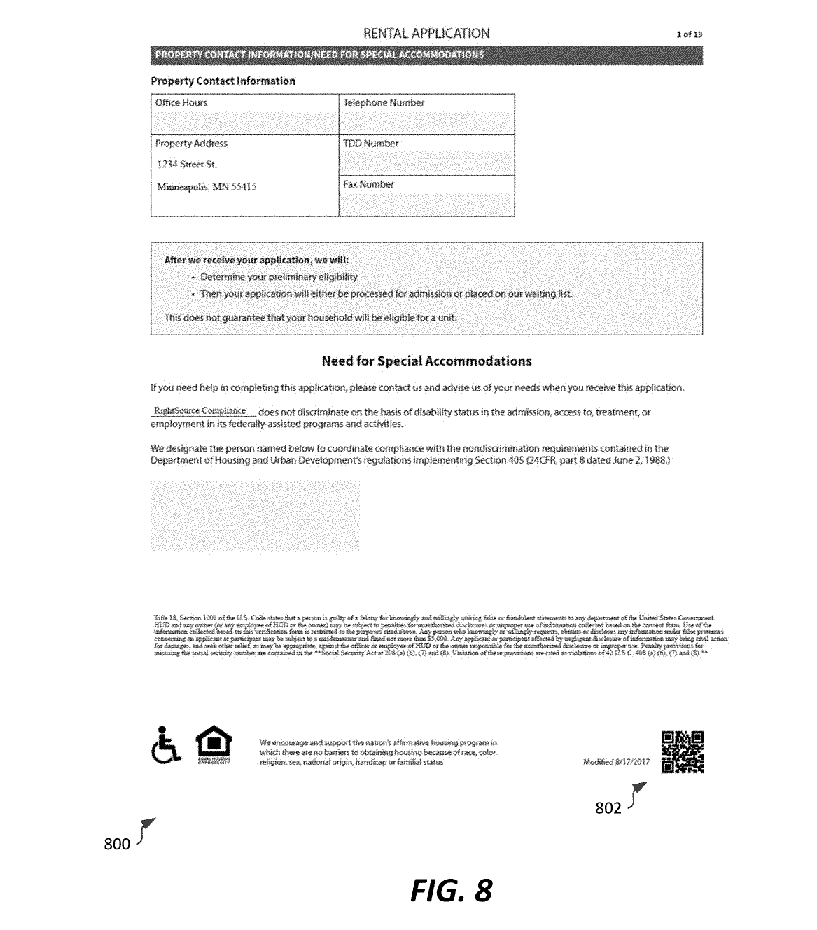

It is noted that even if the correct forms are retrieved for a particular applicant, each form has at least one page, for example, some forms may be 10 pages or more. These pages can easily become lost or out of order, particularly when provided to a prospective tenant in print form and returned at a later time once the prospective tenant has an opportunity to print those forms. Accordingly, in example embodiments, the software tool inserts a unique identifying symbol on each page of each form. FIG. 8 is an example page 800 of a form that includes a quick response (QR) code 802 on a bottom right corner of the page. In example embodiments, each page of each form has a different unique identifier, which identifies to which page and which form that particular page belongs. In still further embodiments, a QR code is affixed to the form at the time the packet is generated, with each page of each form having a unique QR code. This allows each page of each form to be tracked, such that a replacement page of a particular form or packet will have a separate QR code as compared to an original page of the same packet, even if associated with the same user or prospective tenant. Accordingly, each version of the page can be maintained for audit purposes.

The software tool adds the unique identifier after the packet is downloaded from its origin, but before the packet is downloaded and given to the prospective tenant or property manager. The unique identifier is a machine readable marking, such as a matrix codes, such as a QR code, barcode, or other similar machine-readable mediums. For example, the QR code contains information such as which document that page is from and which page number that page corresponds. The QR code can also link each page of the document to specific parts of an auditing process. The unique identifier allows the software tool to identify the page of the document to perform an action specific to the page. Actions may include checking the page for blanks or incompletes, or ensuring a calculation was completed correctly.

In example embodiments, the QR code can be either uniquely assigned to the page of a given application, such that two copies of the same application will have the same QR code on the same page, thereby ensuring that a single page can be readily identified as belonging to a particular application, and can also identify an appropriate location within that application. In alternative embodiments, each application will have a unique QR code applied to each page, such that each page is uniquely marked. This embodiment generally will require that QR codes will be stored in the database 406 for tracking which QR code is associated with which user and application page. Regardless of which method is used, the unique identifier provides a system and method of identifying and authenticating each page of the packet. Therefore, even if the pages are entered into the software tool in an incorrect order or if a page is missing, the software tool is able to use the unique identifier to mitigate such a problem.

Before the audit process can begin, the prospective tenant completes the packet and returns it to the housing organization. The prospective tenant is responsible for completing the packet of forms. In some instances, the prospective tenant is capable of completing all the forms, while in other instances third parties need to complete some of the forms. For example, a prospective tenant may require a bank certification. The prospective tenant may be required to obtain completed forms from the third party. Alternatively, the third party may return completed forms directly to the property manager or auditor. While not shown in the figures, completion of the packet includes, if needed, having a third party complete any necessary third party returns it to the housing organization or the auditor. Once the packet is completed, the prospective tenant returns the packet to the property manager or auditor. After the packet is completed and returned to the property manager or auditor, the packet is uploaded into the software tool.

III. Audit Process and Automated Audit Notifications

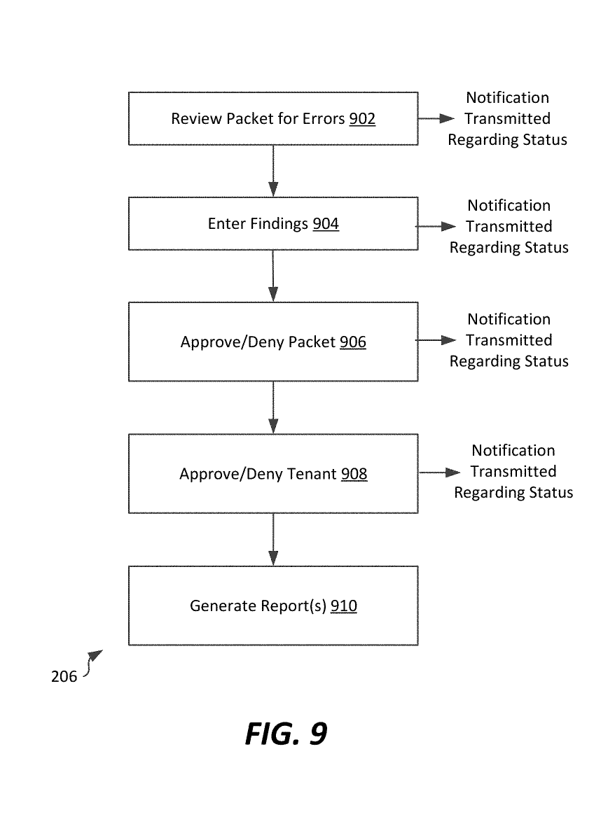

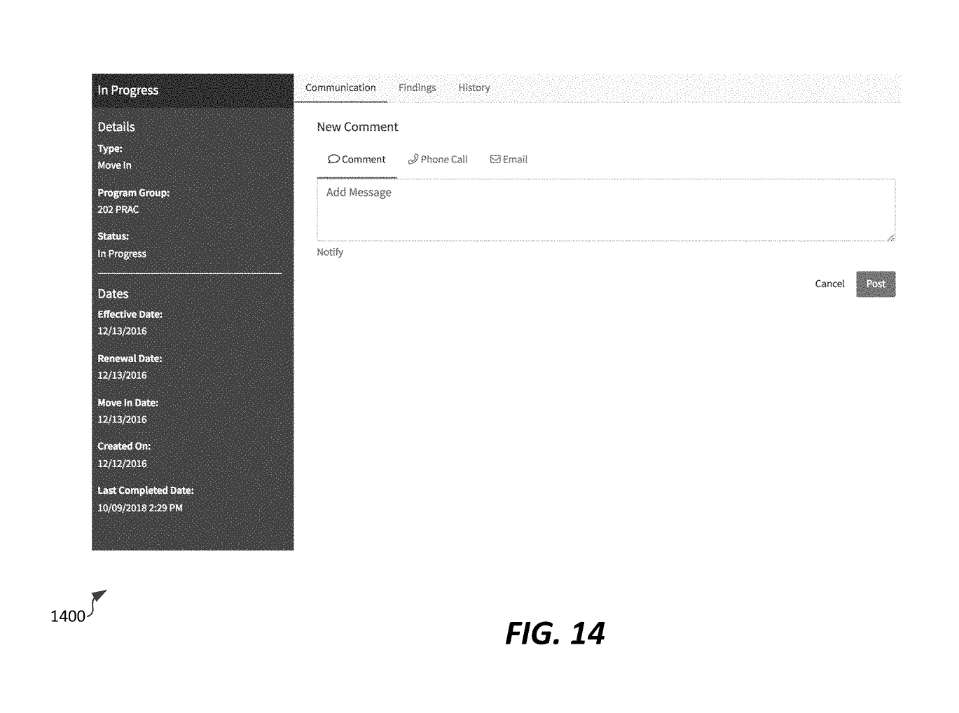

A system for managing an audit process is described further below in connection with FIGS. 9-18. In general, to begin an auditing process, a packet that is completed by a prospective tenant is uploaded to the software tool. In general, and as noted previously, the pages of the packet may be uploaded in any order, since the tool can use the unique identifier on each page to correctly order pages, and determine whether any one or more pages is missing from the uploaded packet. Individual pages or forms can be uploaded to the software tool, for example, when a page was corrected or completed after an initial upload. This allows a third party to return forms to the property manager or auditor as they become completed instead of waiting until the entire packet is completed. Third parties may include banks, employers, educational institutions, and other similar parties.

Generally, the prospective tenant fills out the packet and/or individual documents in hard copy. Since the packet of forms is completed by a prospective tenant in hard copy, the program may utilize optical character recognition (OCR) software or other similar software to recognize the information provided by the prospective tenant. The OCR system is used to gather and/or analyze the information from the packets and individual documents. OCR systems are capable of translating handwritten or typewritten text into machine-editable text or machine-readable text. The software utilizes the unique identifier to categorize each page and to ensure the program is reviewing the correct page.

Referring now to FIGS. 9-18, a generalized audit process is described, in connection with automated audit notifications that can be generated in association with that process. The automated audit notifications can be sent to the submitting user, the prospective tenant, or other entities to whom relevant information may need to be sent (e.g., to obtain corrected application documents or notify of the application status).

FIG. 9 illustrates an overview of an example auditing process 206. In the process 206, a packet that has been received after being previously completed by a prospective tenant is reviewed for errors (step 902). Errors may come in many forms. In example embodiments, reviewing a packet for errors may include a machine-directed review process, for example to validate that all pages of a packet have been received, and that the pages all came from the same packet (e.g., based on QR codes affixed to each page and uniquely associated with each page). Additionally, reviewing a packet for errors may include an at least partially manual process as well. For example, an audit user of the software tool will then use the tool to identify any issues of concern in the packet, also referred to in the present application as “findings”. Such findings are entered (step 904) based on any errors or other concerning characteristics of the application packet that are found. Findings entry can be performed, for example, by an auditor who inspects a completed packet that is ready for an audit process. Then the packet is approved or denied (step 906), and consequently, the prospective tenant is approved or denied (step 908). Additionally, one or more reports may be generated for delivery to a user or used by the auditor regarding audited packets from that user (e.g., from a common housing organization) or from the same auditor, or comparing among auditors (step 910).

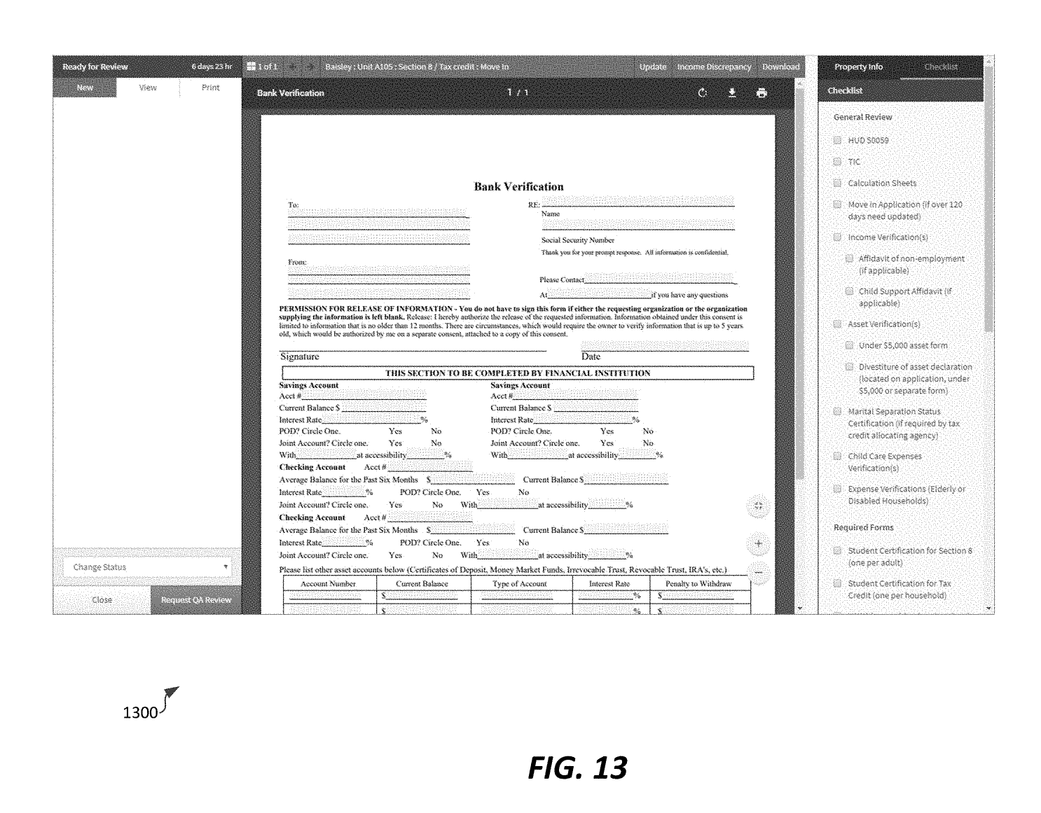

In more detail, once the packet is uploaded to the software tool, an auditing process 206 can be initiated. The auditing process reviews the forms for errors (at step 802) such as incompletely filled forms, forms filled out incorrectly, information that disqualifies a prospective tenant, incorrect calculations, or other similar errors. Auditors follow a checklist for each form, which ensures the forms are completely correctly and in their entirety. One example of such a checklist is illustrated in FIG. 13, below.

During each step of the auditing process 206, a notification regarding the status is transmitted to a prospective tenant and/or property manager. When the packet is being reviewed for errors, a notification is transmitted regarding the status. When findings are entered, a different notification is transmitted. Once a packet is approved or denied, a new notification is transmitted, and finally, when a tenant is approved or denied, a notification is transmitted regarding the status.

In conjunction with the overall process, in certain embodiments, the software tool can include additional user interfaces and reporting mechanisms that allow auditors to identify housing packets that require auditing based on the time since the packet has been submitted, to ensure prompt review of each packet. Additionally, an amount of time required to audit each packet can be monitored for both training and for workload forecasting purposes.

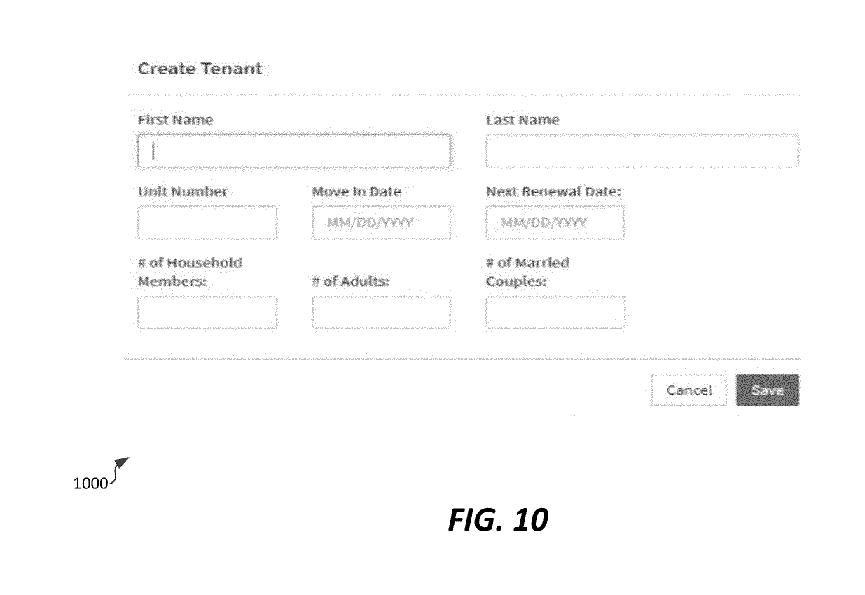

To begin the audit process, a received packet is associated with a prospective tenant. Accordingly, the software tool prompts either a user (at the time a packet is generated) or an auditor (at the time of auditing) to create a prospective tenant profile. An example of a prospective tenant popup 1000 is shown in the screenshot at FIG. 10. Information including the tenant's name, the property being applied to, the number of household members, the number of children, and other similar information is entered into the profile. The software tool links the prospective tenant profile with the associated completed packet. The software tool also notes whether the completed packet is a new application, a replacement application, or a renewal application.

Some types of assistance programs require forms to be completed periodically, i.e., a renewal application. When a program requires such type of recertification, the software tool creates an alert that will alert a user when new documentation is needed. For example, some assistance programs requires a bank verification every year, so the software tool will create an alert every year that a new bank verification needs to be completed. The software tool comprises a docketing system to send alerts to the property manager and/or the prospective tenant/current tenant when new forms are required.

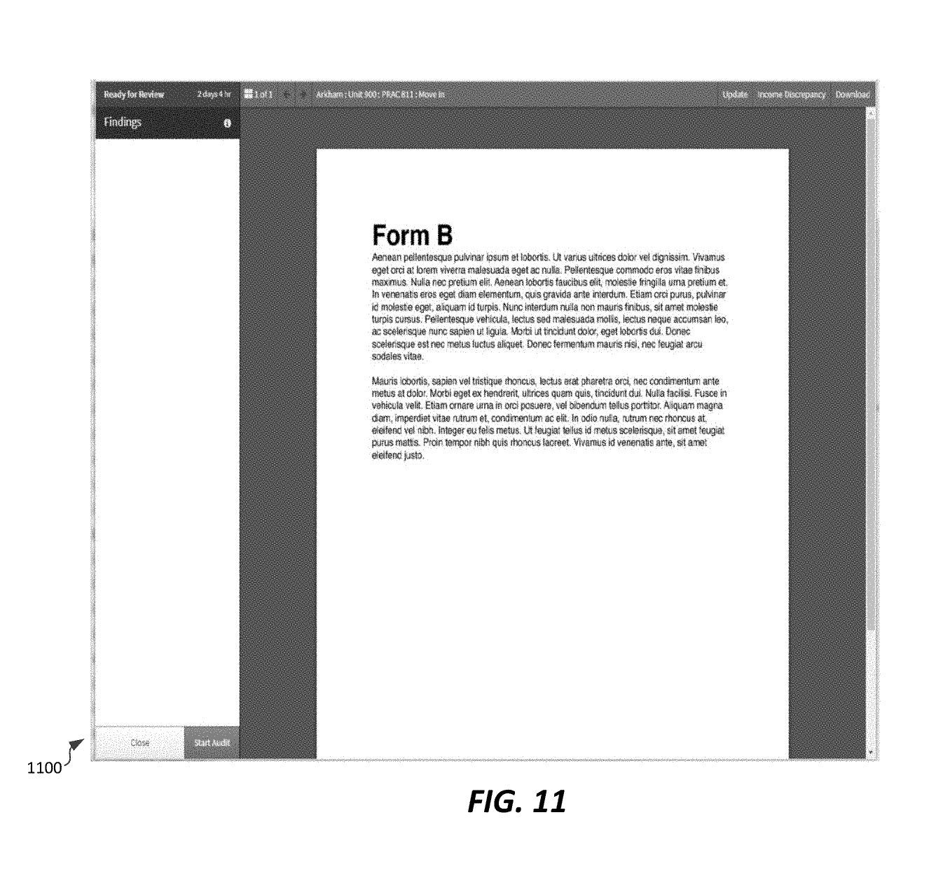

FIG. 11 illustrates an example screenshot of an auditing page 1100. The auditor is able to view the form to be audited on one side of the screen, and to enter notes on the other side of the screen. When an auditor enters a note the software tool links that note to the page that auditor is viewing, and optionally to the specific field or region of the screen on which the issue or discrepancy is found. An auditor is able to review notes later in the auditing process and is able to edit the notes as needed. In embodiments of the present disclosure, the notes generated by the auditor are referred to as “findings”, which generally are intended to refer to discrepancies or missing information that may result in either clarification being required from the prospective tenant or corrective action (e.g., completing a replacement packet due to errors).

As noted above, a finding may also be linked to a specific part of the page. For example, if a calculation is done incorrectly, the auditor is able to select the part of the page that has the incorrect calculation and make a finding that links directly to that particular spot.

When the auditor views the form later, the findings appear linked to the associated page and/or spot. Findings can be edited or deleted throughout the auditing process as needed. Once a finding is deleted, the software tool no longer links that note to the page when viewing during an auditing process, but stores it in the auditing trail information.

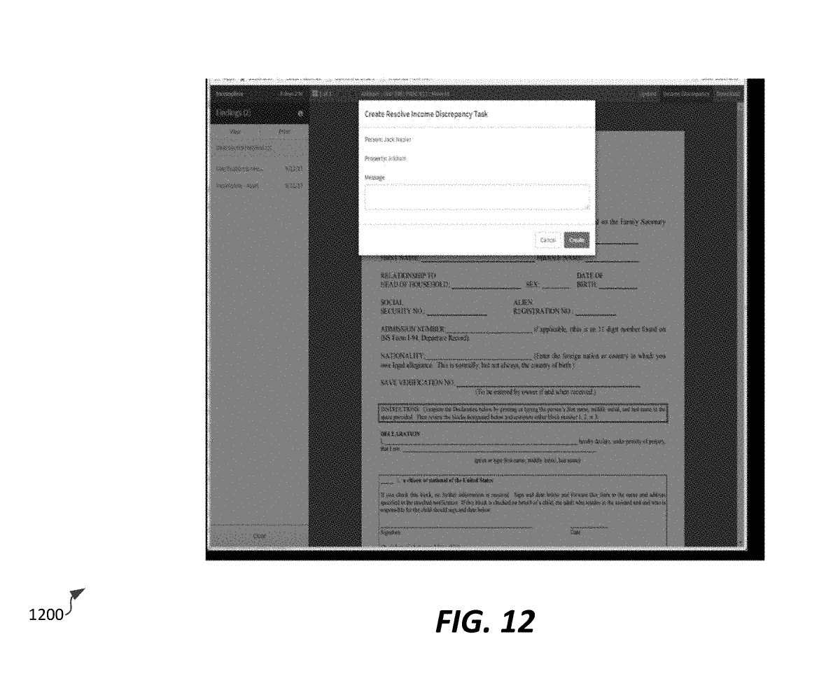

FIG. 12 shows an example screen 1200 that allows the auditor to create a task for resolution of one or more findings in a form. In the example shown, a “create resolve income discrepancy task” is shown, and is associated with a finding that was included in a findings field previously entered by an auditor; in that case, a discrepancy in reported income was found (i.e., the income reporting was not complete). The task will generate a notification to the user or prospective tenant that action is required for completion of the packet.

In conjunction with entry of findings, each auditor has a number of specific tasks to perform in association with each packet, and the specific items reviewed may vary across packets. In the embodiment shown, an example screen 1300 of FIG. 13 includes a checklist panel associated with a packet that displays the various review steps that are required for a particular packet. These review steps can include completion of calculation sheets, assessments of child care expenses, asset verifications, or other audit tasks. By associating appropriate tasks with each packet, audits may be performed by auditors in a more standardized manner.

Also during the audit process, an auditor may need clarification regarding something encountered during the audit process. For example, the auditor may receive specific verification from a housing organization or prospective tenant that clarifies a particular income source, or that a form has been submitted. Because, for audit purposes, such communications or verifications may be tracked, a user interface 1400 can be included within the audit process as well, for tracking comments, notes regarding phone calls, or email exchanges with users and prospective tenants.

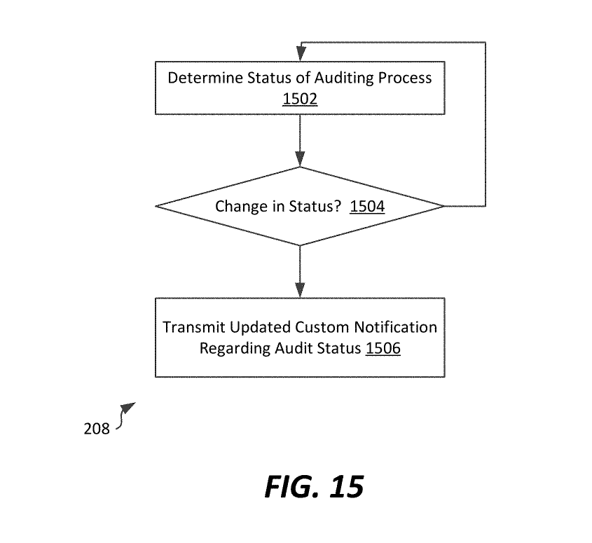

FIG. 15 shows the steps associated with having a customized status notification message regarding the packet is sent to the prospective tenant or the housing organization 208. The software tool is configured to automatically email property managers throughout the auditing process. The software tool determines the status of the auditing process (step 1502) and tracks when there is a change in status (step 1504). Depending on the stage of the auditing process, an updated custom notification regarding an audit status is transmitted (step 1506).

For example, property managers are notified when an application has been received, the auditing process has started, or the application has been approved. Other notification include when duplicate applications are received, applications are canceled, incomplete applications were received, applications have been approved, completed applications have been received, and unqualified applications have been received. Property managers are also notified when there is a change in status, for example, when an audit has been suspended before the application contains a critical error.

Notifications may also be sent to prospective tenants. For example, when a note is created regarding a missing or incomplete page, the software tool can email the prospective tenant to notify them of the issue.

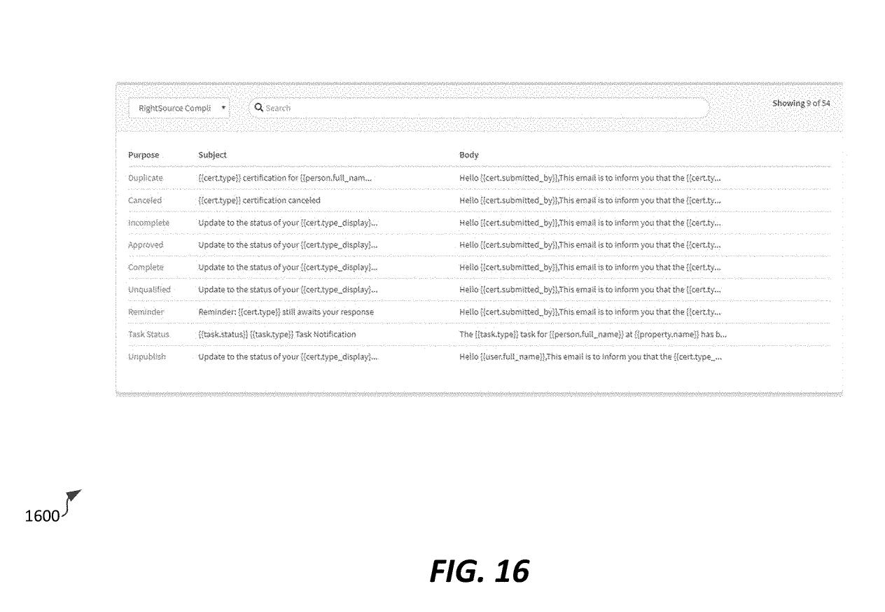

These notifications are saved as templates, and may be sent automatically or when an auditor chooses to send an email. FIG. 16 shows a screenshot of example email templates. Predetermined email templates include, but are not limited to duplicate application received, canceled applications, incomplete applications, approved applications, completed applications, unqualified applications, reminders, task status update, and unpublished applications. Other email templates are also available as needed.

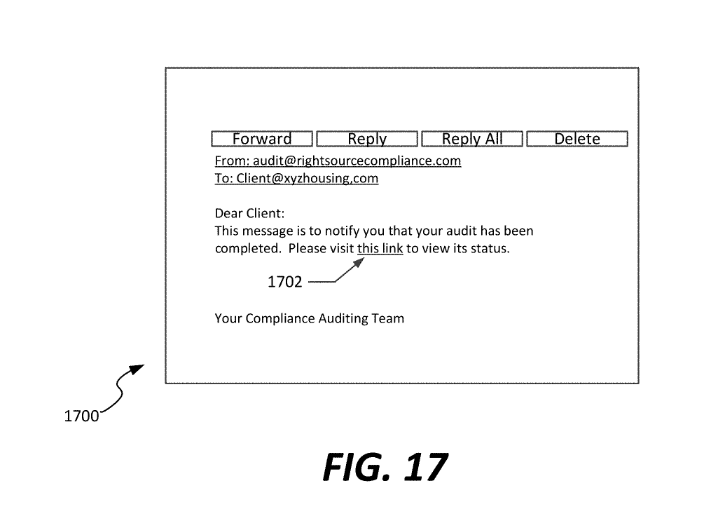

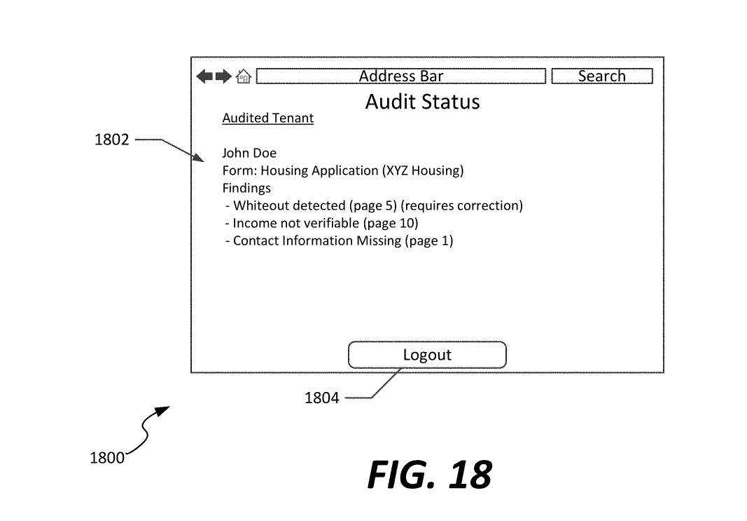

Referring now to FIGS. 17-18, example automated communications to a user or prospective tenant are illustrated. In FIG. 17, an example email communication 1700 is illustrated as being issued from the software tool of the present disclosure to a user from a housing organization. In the example shown, the user receives an email message notifying that an audit has been completed. The email communication 1700 can include, in the embodiment shown, a customized link 1702 that, when visited, launches a browser window to navigate to a web portal at which the user can view a report regarding the one or more audit processes requested by that user. As seen in FIG. 18, a schematic of a screen 1800 presenting such a report can include an indication of the prospective tenant as well as a summary or detailed view 1802 of one or more findings associated with the housing packet that was completed by that prospective tenant.

In example embodiments, the template-based notifications can be configured to be transmitted automatically by the software tool according to a plurality of different delivery mechanisms. For example, in some embodiments, an email status notification can automatically be generated. In other embodiments, a SMS text message may be generated. In still other embodiments, other types of messages can be formed and delivered as well. In some cases, two or more formats can be used, or a format of message can be used based on user or organization preferences.

Referring to FIGS. 1-18 generally, it is noted that the software tool, as well as the generalized platform described herein, provides a number of advantages to users. In particular, it provides a guided process in which users are ensured of using up-to-date housing packets, while encouraging consistency and completeness in audit processes. It also provides increased visibility by users and tenants into the audit process, and manages throughput of such audits, while automatically notifying users and prospective tenants of updates during a housing application process overall.

In conjunction with the present disclosure, it is noted that although in the embodiments described above the housing packet and auditing process is described in conjunction with housing assistance programs, in alternative embodiments the packet generation and auditing processes described herein can be used in conjunction with a non-assisted housing application process as well.

The above specification, examples and data provide a complete description of the manufacture and use of the composition of the invention. Since many embodiments of the invention can be made without departing from the spirit and scope of the invention, the invention resides in the claims hereinafter appended.

1. A method of managing a housing assistance application process, the method comprising:
receiving, at a software tool implemented on a computing system, user input including a set of criteria for a prospective tenant and a housing organization;
based on the prospective tenant and the housing organization, generating a packet of forms comprising at least one application for a selected publicly available housing assistance program from among a plurality of publicly available housing assistance programs having heterogeneous eligibility requirements and application forms,
wherein the packet includes a plurality of pages, each page having a unique identifier thereon identifying the page uniquely relative to any other page of the packet or other application forms;
receiving at the software tool a completed packet representing an application for the selected publicly available housing assistance program;
facilitating an auditing process on the completed packet to determine an eligibility of the prospective tenant for the publicly available housing assistance program; and
transmitting, to a submitter of the completed packet, at least one customized status notification message regarding an audit status of the completed packet, the submitter being at least one of the prospective tenant and the housing organization.

2. The method of claim 1, whererein the audit status identifies one or more corrective tasks to be completed to obtain approval of the application for the selected publicly available housing assistance program.

3. The method of claim 1, further comprising:
receiving, at the software tool, an identification of the housing organization and an identification of the prospective tenant;
in response to the identification of the housing organization and the prospective tenant, identifying to the submitter one or more eligible publicly available housing assistance programs from among the plurality of publicly available housing assistance programs, wherein the selected publicly available housing assistance program is selected from among the identified one or more eligible publicly available housing assistance programs.

4. The method of claim 1, wherein the unique identifier comprises a QR code, wherein each of the plurality of pages is uniquely associated with a different QR code.

5. The method of claim 1, wherein the set of input criteria comprises: where a rental property is located, where the tenant is located, which governmental program is being applied for, how many people reside in a household, and how many students reside in the household.

6. The method of claim 1, wherein the customized status notification message identifies an error in the completed packet in conjunction with the one or more corrective tasks, the error identifying a page in the completed packet on which the error occurs.

7. The method of claim 6, further comprising:
receiving, from the submitter, a corrected page on which the error is identified in the customized status notification message;
inserting the corrected page into the completed packet to form a modified completed packet, wherein the corrected page is inserted into the completed packet at a location based at least in part of a unique identifier of the corrected page matching a unique identifier of a page in the completed packet; and
renewing the auditing process based on the modified completed packet.

8. The method of claim 7, wherein the corrected page and the completed packet are stored in a database.

9. The method of claim 1, further comprising storing an action log associated with at least the auditing process.

10. The method of claim 1, wherein the packet comprises a renewal packet, and the prospective tenant comprises a current tenant.

11. The method of claim 1, wherein the auditing process comprises:
generating an auditing user interface accessible to one or more audit users;
receiving from the audit user an identification of one or more findings associated with the completed packet, the findings representing one or more critical or non-critical errors in the completed application; and
generating a report of the one or more findings.

12. The method of claim 11, wherein the at least one customized status notification message is automatically transmitted to the submitter in response to at least one of: receipt of the completed packet, receipt of a corrected page, identification of a critical error, and completion of the auditing process.

13. The method of claim 1, wherein transmitting the at least one customized status notification message is performed in response to one or more stages of the auditing process.

14. A system for managing a housing assistance application process, the system comprising:
a database storing tenant information, housing organization information, and a plurality of application forms associated with a plurality of publicly available housing assistance programs having heterogeneous eligibility requirements;
a software tool executing on a computing system, the software tool configured to:
receive user input including a set of criteria for a prospective tenant and a housing organization;
based on the prospective tenant and the housing organization, generate a packet of forms comprising at least one application for a selected publicly available housing assistance program from among the application forms in the database;
wherein the packet includes a plurality of pages, each page having a unique identifier printed thereon identifying the page uniquely relative to any other page of the packet or other application forms;
receive a completed packet representing an application for the selected publicly available housing assistance program;
initiate an auditing process on the completed packet to determine an eligibility of the prospective tenant for the publicly available housing assistance program; and
transmit, to a submitter of the completed packet, at least one customized status notification message regarding an audit status of the completed packet, the submitter being at least one of the prospective tenant and the housing organization, and the audit status identifying one or more corrective tasks to be completed to obtain approval of the application for the selected publicly available housing assistance program.

15. The system of claim 14, wherein the computing system comprises a plurality of server computing systems.

16. The system of claim 14, wherein the at least one customized status notification message is automatically transmitted to the submitter in response to at least one of: receipt of the completed packet, receipt of a corrected page, identification of a critical error, and completion of the auditing process.

17. The system of claim 14, wherein the database further stores report information, completed form information, and audit finding information.

18. The system of claim 14, wherein the software tool is configured to automatically generate and transmit the at least one customized status notification message.

19. The system of claim 14, wherein the software tool is configured to automatically generate and transmit a plurality of customized status notification messages in association with each audit process that is initiated, the plurality of customized status notification messages being automatically transmitted at a plurality of different stages of the auditing process.

20. A non-transitory computer-readable medium comprising computer-executable instructions which, when executed by a computing system cause the computing system to perform a method of managing a housing assistance application process, the method comprising:
receiving user input including a set of criteria for a prospective tenant and a housing organization;
in response to the identification of the housing organization and the prospective tenant, identifying to the submitter one or more eligible publicly available housing assistance programs from among the plurality of publicly available housing assistance programs, wherein the selected publicly available housing assistance program is selected from among the identified one or more eligible publicly available housing assistance programs;
based on the prospective tenant and the housing organization, generating a packet of forms comprising at least one application for a selected publicly available housing assistance program from among a plurality of publicly available housing assistance programs having heterogeneous eligibility requirements and application forms,
wherein the packet includes a plurality of pages, each page having a unique identifier thereon identifying the page uniquely relative to any other page of the packet or other application forms;
receiving at the software tool a completed packet representing an application for the selected publicly available housing assistance program;
generating an auditing user interface accessible by an audit user;
facilitating an auditing process on the completed packet to determine an eligibility of the prospective tenant for the publicly available housing assistance program; and
automatically transmitting, in response to one or more stages of the auditing process, at least one customized status notification message to a submitter of the completed packet, the at least one customized status notification message regarding an audit status of the completed packet, the submitter being at least one of the prospective tenant and the housing organization.
